(19) United States
(12) Patent Application Publication
(10) Pub. No.: US 2013/0182025 A1
(43) Pub. Date: Jul. 18, 2013

(54) IMAGE FORMING APPARATUS

(71) Applicant: Atsushi YANAKA, Saitama (JP)

(72) Inventor: Atsushi YANAKA, Saitama (JP)

(21) Appl. No.: 13/738,318

(22) Filed: Jan. 10, 2013

(30) Foreign Application Priority Data
Jan. 12, 2012 (JP) 2012-004462

(51) Int. Cl. B41J 2/045

(52) U.S. Cl. CPC B41J 2/04588
USPC 347/10

(57) ABSTRACT

According to an embodiment, provided is an image forming apparatus that includes: a print head that includes nozzles ejecting liquid droplets, and pressure generating units for ejecting liquid droplets; a drive waveform generating unit that generates and outputs a drive waveform given to the pressure generating units of the print head; a head drive unit that includes a switch unit connected to each pressure generating units, and a selection unit controlling the switch unit to be turned on and off in accordance with image data; a monitoring unit that monitors intermediate potential of the drive waveform; and a unit that outputs a signal for turning on all the switch units, if the monitoring unit detects that voltage is decreased to lower than a predetermined threshold in an interval between the drive waveform of one drive cycle and the drive waveform of a subsequent drive cycle.

### CROSS-REFERENCE TO RELATED APPLICATIONS

The present application claims priority to and incorporates by reference the entire contents of Japanese Patent Application No. 2012-004462 filed in Japan on Jan. 12, 2012.

### BACKGROUND OF THE INVENTION

1. Field of the Invention

The present invention relates to an image forming apparatus.

2. Description of the Related Art

As an image forming apparatus such as a printer, a facsimile, a copying machine, a plotter, and a multifunction peripheral (MFP) thereof, there is known an inkjet recording device as an image forming apparatus provided with a liquid ejection recording structure using a liquid ejection head for ejecting liquid droplets as a print head, for example.

As a head driver that drives a liquid ejection head provided in such an image forming apparatus, there is known a head driver that has an analog switch connected to a piezoelectric element as a pressure generating unit, to which a common drive waveform is input, and a selection unit selecting an analog switch to be turned on (including time during which on-state is maintained) based on a droplet control signal for selecting one or more drive pulses of a plurality of pulses in the common drive waveform and image data.

When a unit such as a piezoelectric element is used as a pressure generating unit of the liquid ejection head, in which sometimes self-discharge occurs, if an interval between drive cycles becomes long, the potential of the piezoelectric element becomes lower than the reference potential of a drive waveform due to self-discharge, which disables to apply the given voltage in a subsequent drive cycle.

Then, there is conventionally known a technique in which signals for forcedly charging a piezoelectric element to reference potential (intermediate potential) of a drive waveform are transmitted to a head driver in the beginning of a drive cycle (Japanese Patent Application Laid-open No. 2010-208219).

As described above, when a unit involving phenomena of self-discharge is used as a pressure generating unit of the liquid ejection head, if an interval between drive cycles is long, the potential of a piezoelectric element is reduced due to self-discharge, which disables normal droplet ejection in a subsequent drive cycle.

On the other hand, in order to reduce the size of an image forming apparatus, it is required that an image is formed even in an acceleration/deceleration periods of a carriage having a print head. However, when such a structure is adopted, a waiting period (standby period) of a drive waveform in a drive cycle becomes long, and droplet ejection characteristics are decreased due to the above-mentioned self-discharge, which makes a deterioration of image quality remarkable.

There is a need to improve image quality with a simple structure in a printer.

### SUMMARY OF THE INVENTION

It is an object of the present invention to at least partially solve the problems in the conventional technology.

According to an embodiment, provided is an image forming apparatus that includes: a print head that includes a plurality of nozzles ejecting liquid droplets, and a plurality of pressure generating units generating pressure for ejecting liquid droplets from the nozzles; a drive waveform generating unit that generates and outputs a drive waveform given to the pressure generating units of the print head in each drive cycle; a head drive unit that includes a switch unit connected to each of the pressure generating units, to which switch unit the drive waveform is input, and a selection unit controlling the switch unit to be turned on and off in accordance with image data; a monitoring unit that monitors intermediate potential of the drive waveform; and a unit that outputs a signal for turning on all of the switch units to the selection unit, if the monitoring unit detects that voltage is decreased to lower than a predetermined threshold in an interval between the drive waveform of one drive cycle and the drive waveform of a subsequent drive cycle.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an explanatory plan view illustrating a main portion of a mechanism of an example of an image forming apparatus of the invention;

FIG. 2 is an explanatory side view illustrating a carriage of the mechanism;

FIG. 3 is an explanatory cross-section view illustrating an example of a liquid ejection head, viewed along a liquid chamber longitudinal direction (direction orthogonal to a nozzle arrangement direction);

FIG. 4 is an explanatory diagram also illustrating a droplet ejection operation;

FIG. 5 is an explanatory block diagram illustrating an outline of a control unit;

FIG. 6 is an explanatory block diagram illustrating an example of a print control unit and a head driver;

FIG. 7 is a circuit diagram illustrating an example of an analog switch of the head driver;

FIG. 8 is an explanatory diagram illustrating an example of the decrease of voltage due to self-discharge of a piezoelectric element and a potential change thereof because of a drive waveform applied;

FIG. 9 is an explanatory diagram illustrating a potential change of the piezoelectric element when the analog switch is turned on between drive waveforms;

FIG. 10 is an explanatory diagram illustrating an example of functional operation of a head drive module of the invention;

FIG. 11 is an explanatory diagram illustrating examples of signals input to the head drive module;

FIG. 12 is an explanatory diagram illustrating examples of droplet control data MD and a latch signal ML that are input to the head drive module, and droplet control signals MN generated.

FIG. 13 is an explanatory diagram illustrating a case in which the droplet control signal is transmitted in parallel;

FIG. 14 is an explanatory diagram illustrating a case in which the droplet control data is transmitted in serial;

FIG. 15 is an explanatory diagram illustrating potential applied on the piezoelectric element when all analog switches are turned on during an ejection waiting period between drive waveforms;

FIG. 16 is an explanatory diagram illustrating a common drive waveform used for explaining an experiment result of change in drop voltage of the drive waveform and change in droplet ejection speed;

FIG. 17 is also an explanatory diagram illustrating voltage applied on the piezoelectric element;

FIG. 18 is also an explanatory diagram illustrating an experiment result of change in drop voltage and change in droplet ejection speed; and

FIG. 19 is an explanatory diagram illustrating the relation between a movement range, and a movement speed of the carriage and a waiting period.

### DETAILED DESCRIPTION OF THE PREFERRED EMBODIMENTS

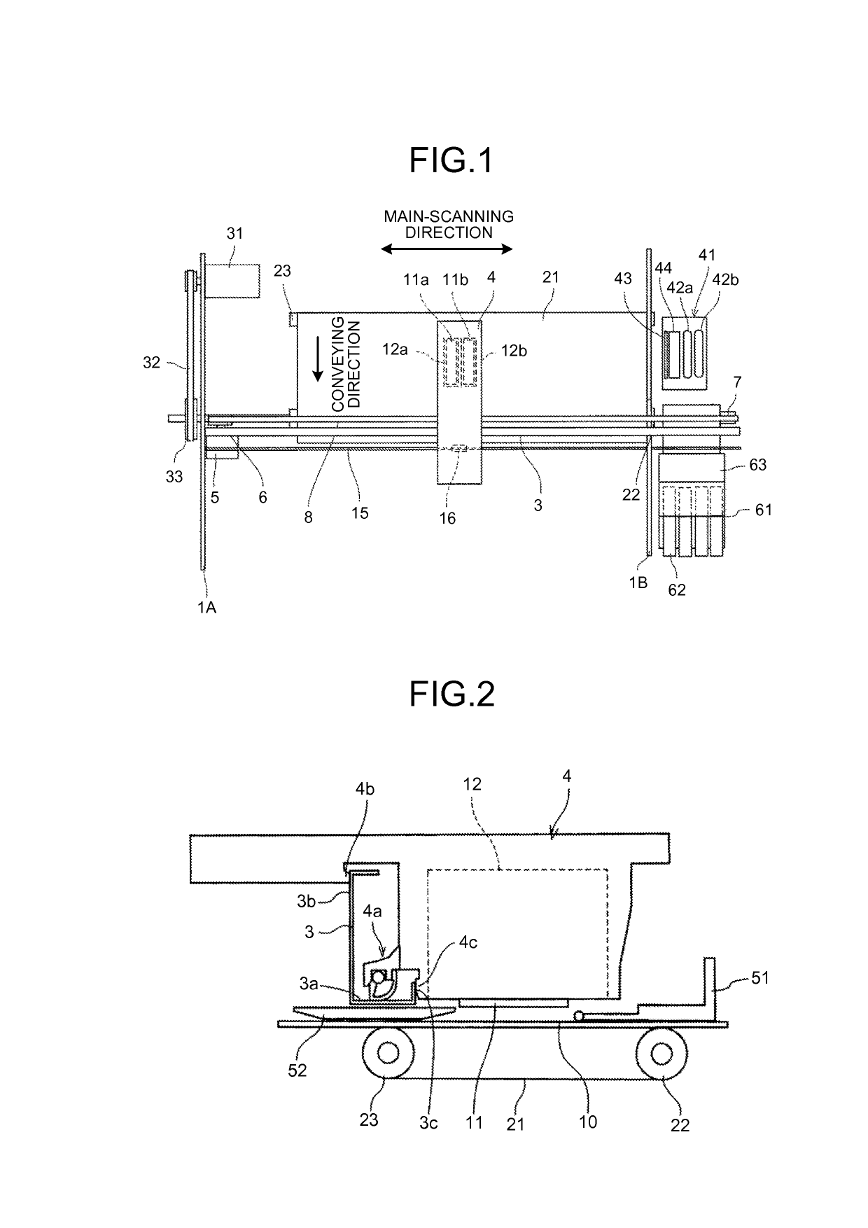

An embodiment of the invention is described with reference to the enclosed drawings. An example of an image forming apparatus of the invention is described with reference to FIG. 1 and FIG. 2. FIG. 1 is an explanatory plan view illustrating a main portion of a mechanism of the image forming apparatus, and FIG. 2 is an explanatory side view illustrating a carriage of the mechanism.

The image forming apparatus is a serial type image forming apparatus. A guiding member 3, formed of a plate-form member as a guide member extended between left and right side plates 1A and 1B, supports a carriage 4 so that the carriage 4 can move in a main-scanning direction. A main-scanning motor 5 moves the carriage 4 for scan in the main-scanning direction through a timing belt 8 suspended in a tensioned manner between a drive pulley 6 and a driven pulley 7.

Here, the guiding member 3 for guiding the movement of the carriage 4 is of a plate-form member, and has a guiding face 3a that is a supporting face for guiding the carriage 4 in a movable manner, and guiding faces 3b and 3c.

The carriage 4 is provided with a so-called rod-less type guiding mechanism including a height adjusting unit 4a supported by the guiding face 3a of the guiding member 3 in a movable manner, a contact portion 4b in contact with the guiding face 3b in a movable manner, and a contact portion 4c in contact with the guiding face 3c in a movable manner.

On the carriage 4, provided are print heads 11a and 11b (hereinafter, referred to as “print head(s) 11”, when the print heads 11a and 11b are not distinguished from each other) constituted by liquid ejection heads as image forming units ejecting liquid droplets of colors of yellow (Y), cyan (C), magenta (M), and black (K), respectively, so that a nozzle array of a plurality of nozzles are provided in a sub-scanning direction that are orthogonal to the main-scanning direction, with the droplet ejection direction being set downward.

Each of the print heads 11 has two nozzle arrays, and the four nozzle arrays eject liquid droplets of colors of Y, M, C, and K allocated thereto respectively.

The print heads 11a and 11b have head tanks 12a and 12b respectively that are provided in integrated manner. The head tanks 12a and 12b supply the print heads 11 with ink. On the side of the apparatus body, liquid cartridges (main tank, hereinafter, referred to as “ink cartridge(s)”) 62 are attached and detached in an exchangeable manner on a cartridge holder 61. A liquid feed pomp unit 63 supplies the head tanks 12 with ink (liquid) from the ink cartridges 62 through a feed tube 64.

An encoder scale 15 is provided along the main-scanning direction of the carriage 4. An encoder sensor 16 is constituted by a transmission type photo sensor and reads divisions (scales: position identifying portion) of the encoder scale 15. The encoder sensor 16 is provided to the carriage 4. The encoder scale 15 and the encoder sensor 16 constitute a linear encoder as a position detecting device.

A carriage belt 21 serves as a conveying unit conveying a sheet 10 in the sub-scanning direction and is provided on the lower side of the carriage 4. The carriage belt 21 is an endless belt, suspended between a carriage roller 22 and a tension roller 23. A sub-scanning motor 31 drives the carriage roller 22 to rotate through a timing belt 32 and a timing pulley 33, and thus the carriage belt 21 is moved around in the sub-scanning direction.

Sheet guiding members 51 and 52 are provided at an entrance portion and an exit portion of the carriage belt 21, respectively.

Moreover, on one side in the main-scanning direction of the carriage 4, a maintaining and recovering mechanism (maintenance unit) 41 is provided to maintain and recover the print head 11 and is provided on the side of the carriage belt 21. The maintaining and recovering mechanism 41 is constituted, for example, by a suction cap 42a and a moisturizing cap 42b that cap nozzle faces (face on which the nozzles are formed) of the print heads 11, a wiper member 43 that wipes the nozzle face, an idle ejection receiver 44 to which liquid droplets not contributing to image formation are ejected. A suction pump (not illustrated) serves as a suction unit and is connected to the suction cap 42a.

A feeding unit that feeds sheets to the carriage belt 21, a paper cassette constituting, for example, a discharging unit that discharges a sheet on which liquid ejected from the print head 11 serving as an image forming unit is adhered so that an image is formed, and discharge sheets, are attached on the apparatus body in a removable manner, although these are not illustrated in the drawings.

In the image forming apparatus with such a structure, fed sheets are conveyed by the carriage belt 21 intermittently, and the print heads 11 are driven in accordance with image signals while the carriage 4 is moved in the main-scanning direction. Thus, liquid droplets are ejected to a sheet that is stopped so as to print one line, and after the sheet is conveyed with a given amount, the subsequent line is printed. Such an operation is performed repetitively to form an image on the sheet. After the image is formed, the sheet is discharged.

When the state of the nozzles of the print head 11 is maintained and recovered, the carriage 4 is moved to a home position facing the maintaining and recovering mechanism 41, and the print head 11 is subjected to recovery operation such as nozzle suction through the nozzles with capping by the suction cap 42a; and idle ejection in which liquid droplets not contributing to image formation are operated against the suction cap 42a or the idle ejection receiver 44. With such recovery operation, it is possible to perform image formation with stable ejection of liquid droplets.

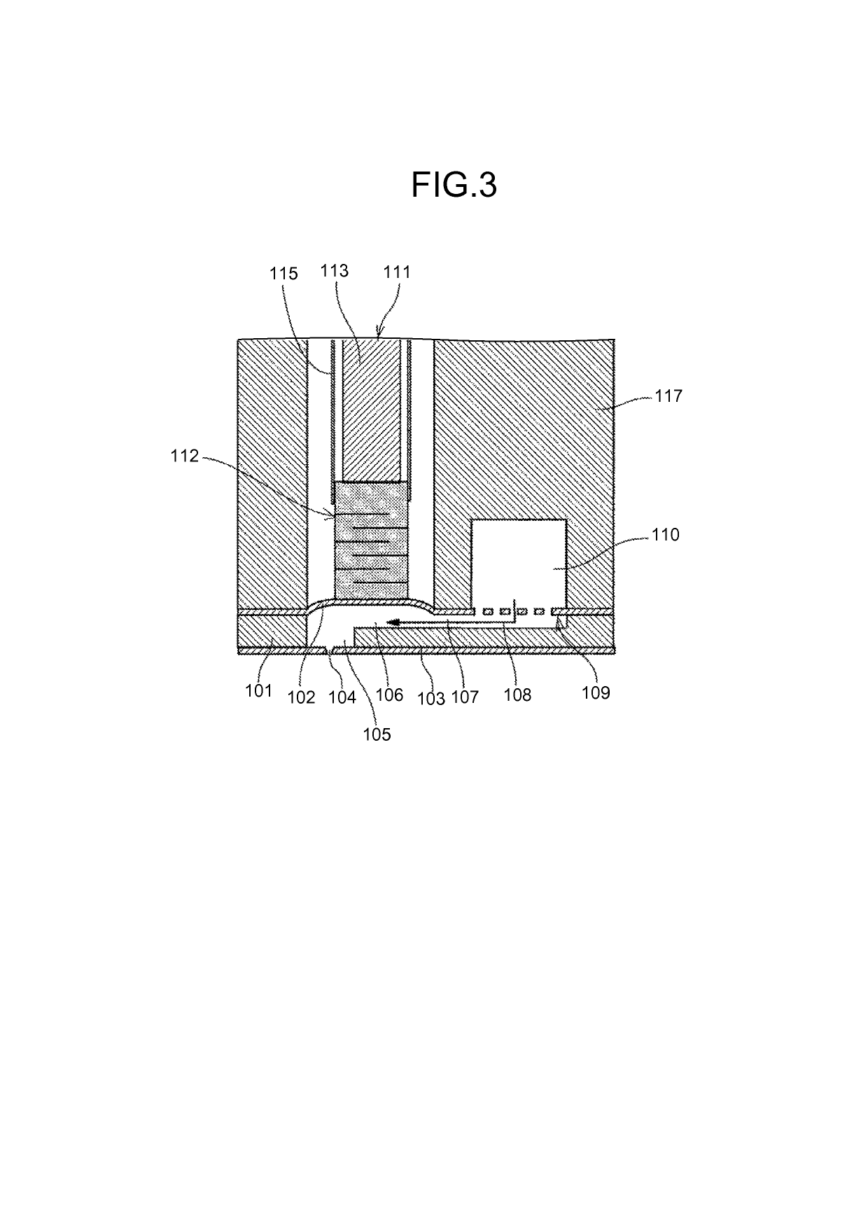

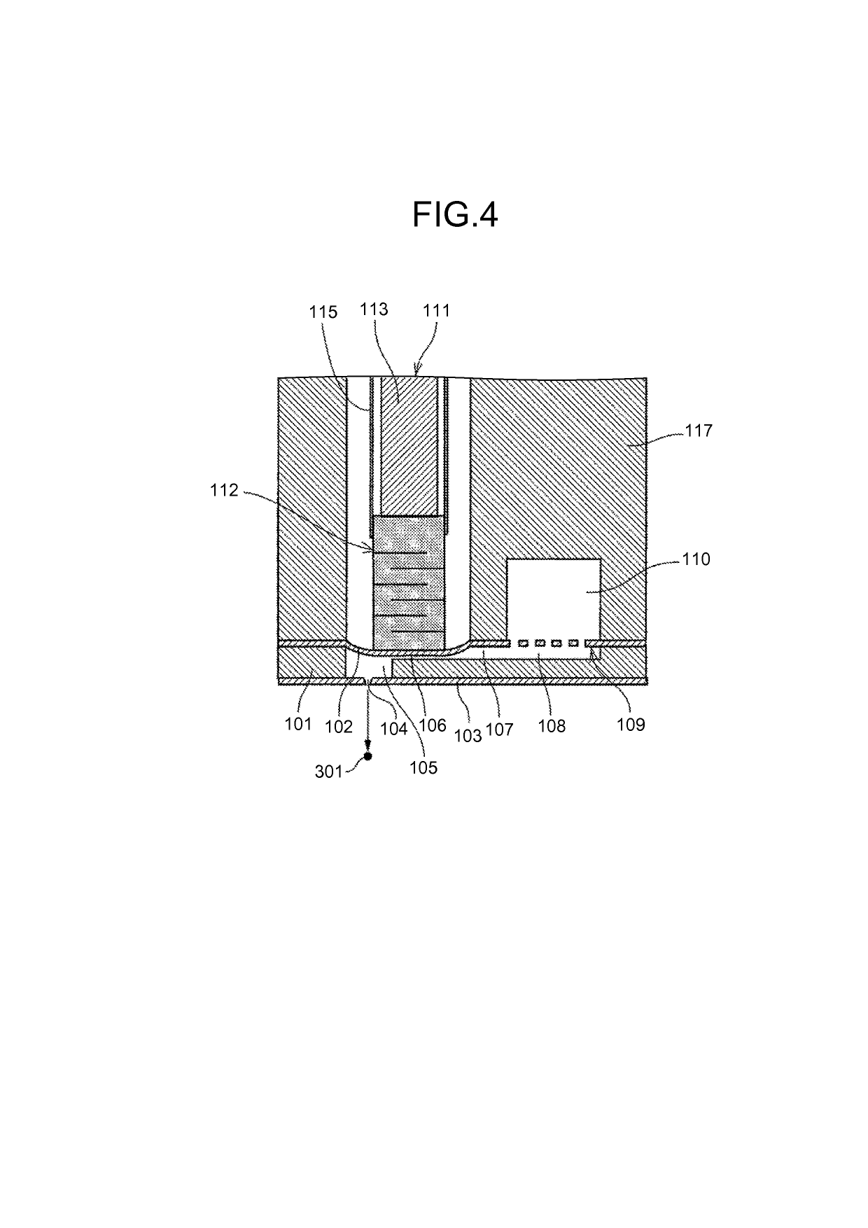

Next, an example of the liquid ejection head constituting the print head 11 is described with reference to FIG. 3 and FIG. 4. FIG. 3 and FIG. 4 are explanatory cross-section views of the print head 11, viewed along a liquid chamber longitudinal direction (direction orthogonal to a nozzle arrangement direction).

The liquid ejection head has an individual liquid chamber (including a pressing chamber, a pressing liquid chamber, a pressure chamber, an individual channel, an pressure generating chamber, etc.; hereinafter, simply referred to as a “liquid chamber”) 106 defined by junction of a channel plate 101, a vibrating plate member 102, and a nozzle plate 103, to which a nozzle 104 ejecting liquid droplets is communicated through an through hole 105; a liquid resisting unit 107 supplying the liquid chamber 106 with liquid; and a liquid introducing unit 108. Liquid (ink) is introduced from a common liquid chamber 110 formed in a frame member 117 to the liquid introducing unit 108 through a filter 109 formed on the vibrating plate member 102, and then the ink is supplied from the liquid introducing unit 108 to the liquid chamber 106 through the liquid resisting unit 107.

The channel plate 101 includes laminated metallic plates such as stainless steel (SUS), which defines openings or grooves of the through hole 105; the liquid chamber 106; the liquid resisting unit 107; and the liquid introducing unit 108, for example. The vibrating plate member 102 is a wall face member constituting wall faces of the liquid chamber 106, the liquid resisting unit 107, the liquid introducing unit 108, etc., and the vibrating plate member 102 is also a member constituting the filter 109 as well. Note that the channel plate 101 can be also formed by anisotropic etching of a silicon substrate, instead of the above-mentioned metallic plate such as SUS.

A laminated type piezoelectric member (piezoelectric element) 112 is joined to a face of the vibrating plate member 102 that is opposite to a face on the side of the liquid chamber 106. The laminated type piezoelectric member 112 is a columnar electromechanical converting element and serves as a driving element (actuator unit, pressure generating unit) that generates energy for pressuring ink in the liquid chamber 106 and ejecting liquid droplets from the nozzle 104. A base member 113 is joined to one end of the piezoelectric member 112, and a flexible printed circuit (FPC) 115 transmitting drive waveforms is connected to the piezoelectric member 112. These constitute a piezoelectric actuator 111. The piezoelectric member 112 is divided to a plurality of columnar piezoelectric elements (piezoelectric columns) through slits.

In the example, the piezoelectric member 112 is used in a d33 mode in which it is extended and contracted in the lamination direction thereof. However, the piezoelectric member 112 may be used in a d31 mode in which it is extended and contracted in a direction orthogonal to the lamination direction.

In the liquid ejection head with such a structure, the piezoelectric element 112 is contracted when the voltage applied on the piezoelectric elements (piezoelectric columns) 112 is lowered from reference potential Ve, so that the vibrating plate member 102 is deformed and the volume of the liquid chamber 106 is increased, whereby ink is flowed into the liquid chamber 106, as illustrated in FIG. 3, for example. Thereafter, the piezoelectric element 112 is extended in the lamination direction when the voltage applied on the piezoelectric element 112 is increased, so that the vibrating plate member 102 is deformed toward the nozzle 104 and the volume of the liquid chamber 106 is decreased, whereby ink in the liquid chamber 106 is pressured and a liquid droplet 301 is ejected from the nozzle 104.

Then, when the voltage applied on the piezoelectric element 112 is returned to the reference potential Ve, the vibrating plate member 102 is restored at an initial position and the liquid chamber 106 is expanded to generate negative pressure. Here, the liquid chamber 106 is filled with ink from the common liquid chamber 110. Then, the process shifts to the operation for the subsequent ejection of liquid droplets after the vibration of a meniscus face of the nozzle 104 is decreased and the face is stabilized.

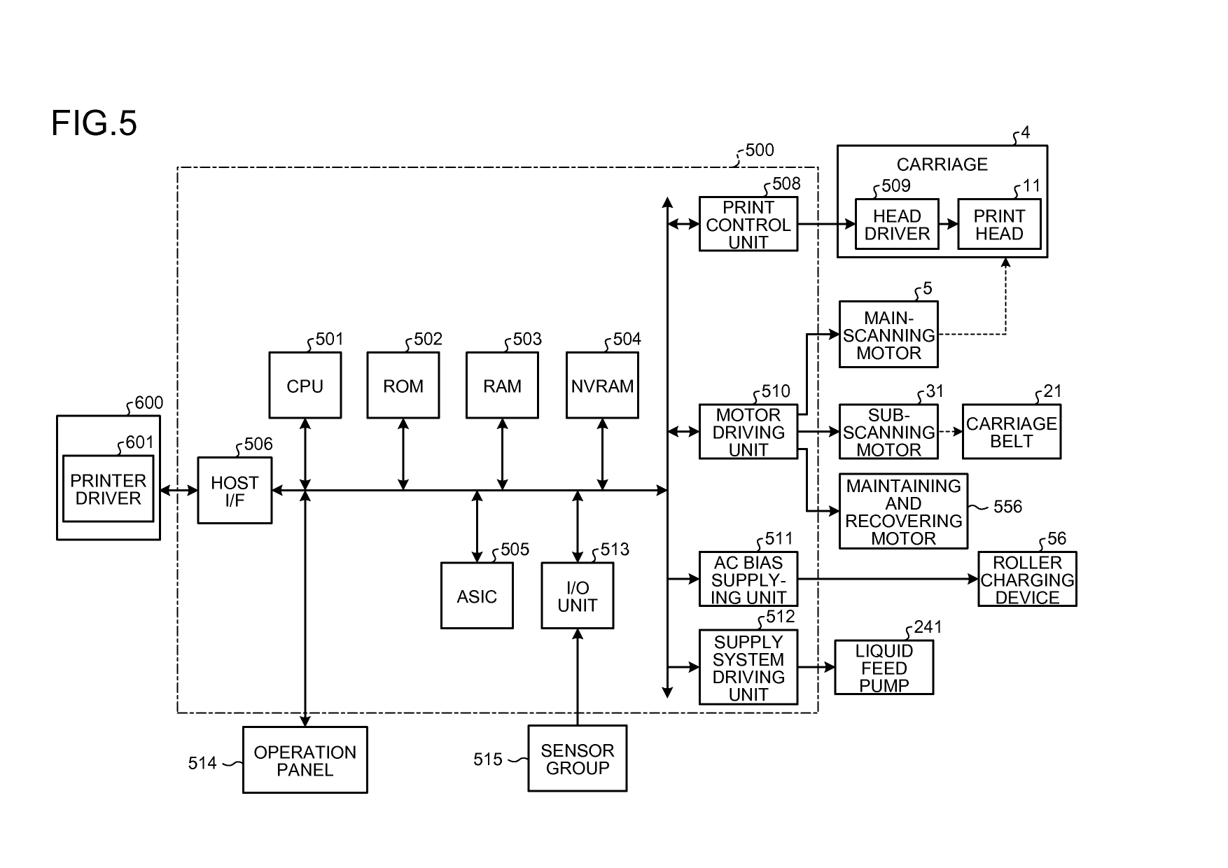

The outline of a control unit of the image forming apparatus is described with reference to FIG. 5. FIG. 5 is an explanatory block diagram illustrating the control unit.

A control unit 500 has a central processing unit (CPU) 501 controlling the entire apparatus; a read only memory (ROM) 502 storing fixed data such as various programs including a program executed by the CPU 501; a random access memory (RAM) 503 temporarily storing image data, etc.; a rewritable nonvolatile memory 504 for maintaining data even while power supply of the apparatus is cut off; and an application specific integrated circuit (ASIC) 505 that performs various kinds of signal processing on image data, image processing including sorting, and other processing on input and output signals for controlling the entire apparatus.

Moreover, there are provided a print control unit (controller) 508 including a data transmitting unit and a drive signal generating unit for driving and controlling the print head 11; a head driver (driver IC) 509 that is a head drive module of the invention for driving the print head 11 provided on the side of the carriage 4; a motor driving unit 510 for driving the main-scanning motor 5 moving the carriage 4 for scan, the sub-scanning motor 31 moving the carriage belt 21 around, a maintaining and recovering motor 556 moving a cap 42 and the wiper member 43 of the maintaining and recovering mechanism 41; an alternating current (AC) bias supplying unit 511 for supplying AC bias to a roller charging device 56; and a supply system driving unit 512 for driving a liquid feed pump 241, for example.

An operation panel 514 is connected to the control unit 500 and is used for input and display of information necessary for the apparatus.

The control unit 500 has an interface (I/F) 506 for transmitting and receiving data and signals to and from a host. The control unit 500 receives data and signals with the I/F 506 from a host 600, e.g., an information processing device such as a personal computer, an image scanning device such as an image scanner, and an image capturing device such as a digital camera, through a cable or a network.

The CPU 501 of the control unit 500 reads out print data in a reception buffer of the I/F 506 to analyze it. Then, after necessary image processing, data sorting processing, etc. are performed in the ASIC 505, the image data is transmitted from the print control unit 508 to the head driver 509. It is possible that dotted pattern data for outputting the image be generated by a printer driver 601 included in the host 600 or by the control unit 500.

The print control unit 508 transmits the image data as serial data, and outputs for example a transmission clock and latch signals required for transmitting the image data and determining the transmission; and droplet control signals selecting a given drive pulse from a drive waveform, to the head driver 509. In addition, the print control unit 508 has a drive signal generating unit constituted by, for example, a digital-to-analog (D/A) converter that D/A-converts pattern data of drive pulses stored in the ROM; a voltage amplifier; and a current amplifier. And the print control unit 508 outputs a drive waveform (common drive waveform) of a plurality of drive pulses to the head driver 509.

The head driver 509 selects drive pulses forming the common drive waveform received from the print control unit 508 based on image data input in serial that corresponds to one line of the print head 11, and applies the selected drive pulses on the piezoelectric member 112 serving as a pressure generating unit generating energy of the print head 11 for ejecting liquid droplets so as to drive the print head 11. Here, it makes it possible to distinctively print dots of different sizes such as large-sized droplets, middle-sized droplets, and small-sized droplets by selecting one part of pulses forming the drive waveform or the entire thereof, or by selecting one part of waveform components forming the pulse or the entire thereof.

An input/output (I/O) unit 513 obtains information from a group of various sensors 515 installed in the apparatus, and extracts information necessary for controlling the printer to use the information to control the print control unit 508, the motor driving unit 510, and the AC bias supplying unit 511. The sensor group 515 includes an optical sensor for detecting a position of sheets; a thermistor for monitoring a temperature of the inside of the apparatus; a sensor for monitoring voltage of a charged belt; and an interlock switch for detecting opening and closing of a cover, for example. The I/O unit 513 can process various kinds of sensor information.

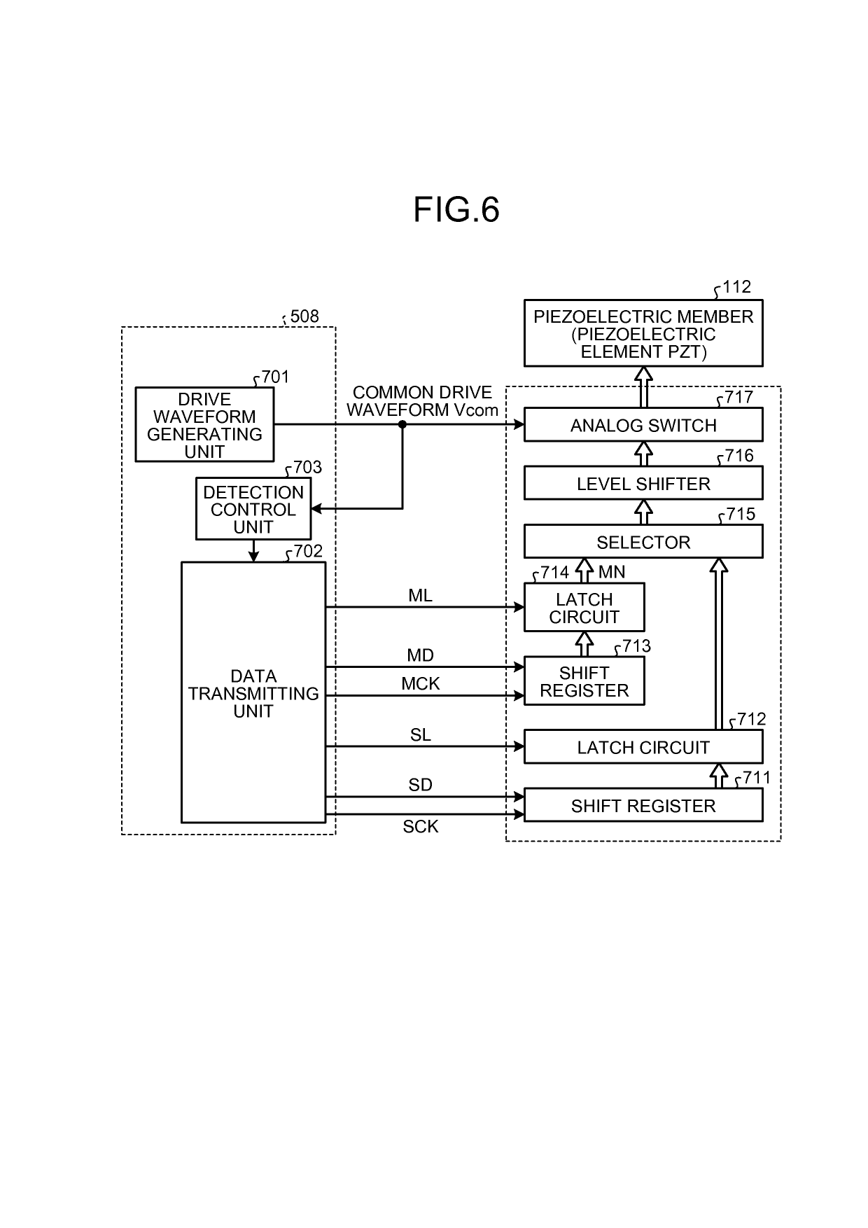

Next, examples of the print control unit 508 and the head driver 509 are described with reference to the block explanatory diagram of FIG. 6.

The print control unit 508 has a drive waveform generating unit 701 that generates a drive waveform (common drive waveform) Vcom including a plurality of drive pulses (drive signals) in one print cycle (one drive cycle) and outputs the drive waveform when forming an image; and a data transmitting unit 702 that outputs image data and signals for controlling the head driver 509 depending on the image data.

The data transmitting unit 702 transmits: image data SD (SD0 and SD2, here) with the number of bits necessary for a print image; shift clock signals SCK for image data; latch signals SL for image data; droplet control data (analog switch control data) MD for selecting a necessary drive pulse in the common drive waveform Vcom; shift clock signals MCK for droplet control data MD; and latch signals ML for droplet control data MD. Here, the image data SD and the droplet control data MD are sent to the head driver 509 in serial transmission.

The head driver 509 is a head driving unit, and has a shift register 711 that takes in the image data SD sent in serial transmission from the data transmitting unit 702 with the shift clock signals SCK; and a latch circuit (register) 712 for latching each registration value of the shift register 711 by the latch signals SL.

In addition, the head driver 509 has a shift register 713 that takes in the droplet control data MD sent in serial transmission from the data transmitting unit 702 with the shift clock signals MCK; and a latch circuit (register) 714 for latching each registration value of the shift register 713 by the latch signals ML.

Furthermore, the head driver 509 has a selector 715 that outputs signals for selecting an analog switch 717 to be selected depending on the droplet control signals (analog switch control signals) MN generated based on the image data latched in the latch circuit 712 and the droplet control data MD latched in the latch circuit 714; a level shifter 716 that converts a level of logic level voltage signals of the selector 715 to a level at which the analog switch 717 can operate; and the analog switch 717 that is turned on and off (opened and closed) based on the output of the selector 715 through the level shifter 716.

The analog switch 717 is a switch unit. The analog switch 717 is connected to a selection electrode (individual electrode) of each piezoelectric column (that is referred to as a “piezoelectric element PZT”) of the piezoelectric member 112, and the common drive waveform Vcom from the drive waveform generating unit 701 is input to the analog switch 717. Note that a selection unit is constituted by the parts other than the analog switch 717.

Thus, a necessary pulse (or waveform components) constituting the common drive waveform Vcom is passed (selected) and applied on the piezoelectric elements PZT of the piezoelectric member 112 when the analog switch 717 is turned on or off in accordance with the result of decoding by the selector 715 of the droplet control signals MN generated based on the image data and the droplet control data MD that are sent in serial transmission.

A detection control unit 703 is a monitoring unit. The detection control unit 703 monitors the common drive waveform Vcom generated and output by the drive waveform generating unit 701, and if the midpoint potential (reference potential) of the common drive waveform Vcom becomes lower than a predetermined threshold (and the detection control unit 703 detects such an event), the detection control unit 703 notifies the data transmitting unit 702 of the event.

When the detection control unit 703 detects that the intermediate potential (reference potential) Ve of the common drive waveform Vcom becomes lower than a predetermined threshold, the data transmitting unit 702 controls to shift the states of the droplet control data MD, the clock signals MCK, and the latch signals ML so that the droplet control signals MN for turning on all of the analog switches 717 are output from the latch circuit 714, as described later.

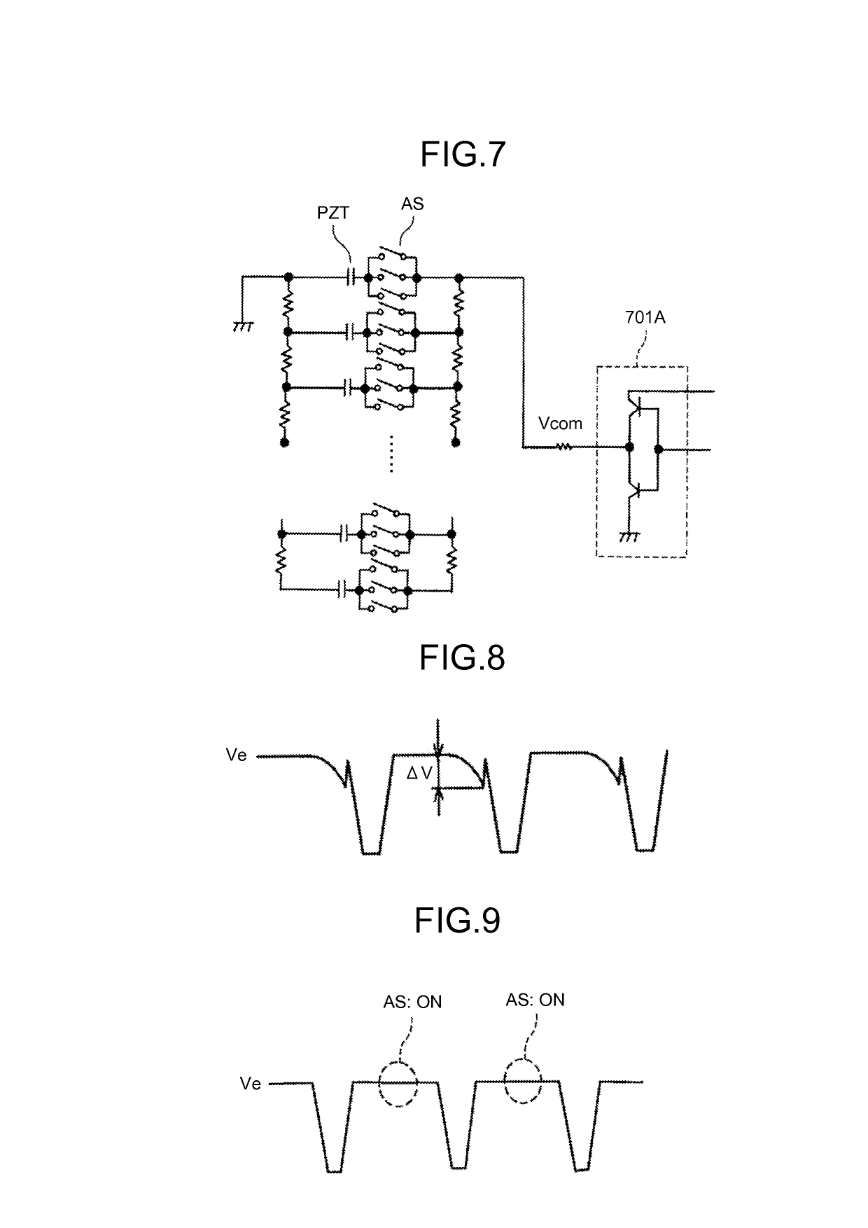

Subsequently, with reference to FIG. 7 to FIG. 9, explanations are made on the decrease of voltage due to self-discharge of the piezoelectric element and the change of voltage because of the drive waveform applied of the invention. FIG. 7 is a circuit diagram illustrating an example of the analog switch of the head driver. FIG. 8 is an explanatory diagram illustrating an example of the decrease of voltage due to self-discharge of the piezoelectric element and the potential change thereof because of the drive waveform applied. FIG. 9 is an explanatory diagram illustrating the potential change of the piezoelectric element when the analog switch is turned on between drive waveforms.

First, as illustrated in FIG. 7, the analog switches AS are connected to selection electrodes (individual electrodes) of the piezoelectric elements PZT respectively, and the common drive waveform Vcom from a current amplifier 701A of the drive waveform generating unit 701 is input to the analog switches AS.

Therefore, a necessary drive pulse constituting the common drive waveform Vcom is passed (selected) and applied on the piezoelectric elements PZT when a necessary analog switch AS is turned on in accordance with the transmitted image data and the generated droplet control signals MN.

Here, if the analog switch AS is off during an interval between the applying of the drive pulse selected from the common drive waveform Vcom of one drive cycle and the applying of the drive pulse selected from the common drive waveform Vcom of the subsequent drive cycle, the potential of both ends of the piezoelectric elements PZT is decreased by AV due to self-discharge, as illustrated in FIG. 8. Then, when a drive pulse is applied in the subsequent drive cycle, the potential of the piezoelectric elements PZT is returned to the reference potential (intermediate potential) of the common drive waveform Vcom from the state in which the voltage is decreased.

That is, in simplified explanation, when a drive pulse of the common drive waveform Vcom is applied in each drive cycle on the piezoelectric elements PZT whose voltage is decreased due to self-discharge, the potential of the piezoelectric elements PZT is increased toward the reference potential Ve of the common drive waveform Vcom from the decreased level, and then varied in accordance with a waveform of drive pulses, as illustrated in FIG. 8.

Here, once the voltage is decreased lower than a given value due to self-charge, the voltage is returned to the reference potential Ve, which causes the extension displacement of the piezoelectric elements PZT. Thus, the volume of the liquid chamber 106 is decreased through the vibrating plate member 102, possibly ejecting liquid droplets.

Therefore, in the embodiment, the print control unit 508 outputs signals for turning on all of the analog switches 717 (group of the analog switches AS) to the head driver 509 in an ejection standby period (waiting period) between the common drive waveform Vcom of one drive cycle and the common drive waveform Vcom of the subsequent drive cycle.

In this manner for example, the analog switches AS are turned on in an interval between the common drive waveforms Vcom of successive drive cycles, and thus the piezoelectric elements PZT are charged to the reference potential Ve, as illustrated in FIG. 9.

Thus, even if the analog switch AS is turned on and the reference potential Ve is applied when a necessary drive pulse of the common drive waveform Vcom is applied in the subsequent drive cycle, it is possible to prevent the ejection of liquid droplets due to displacement of the piezoelectric elements PZT. Therefore, the image quality is prevented from deterioration due to droplet ejection at improper timing.

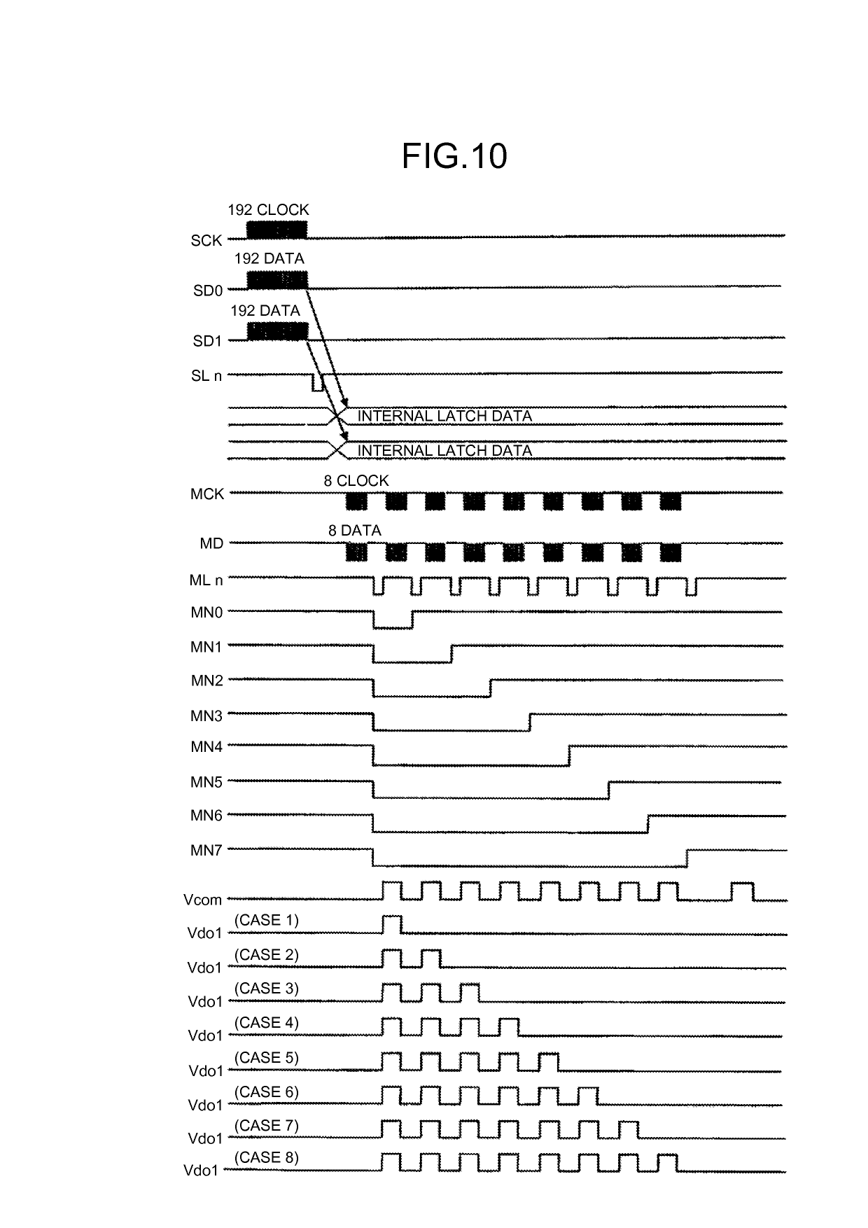

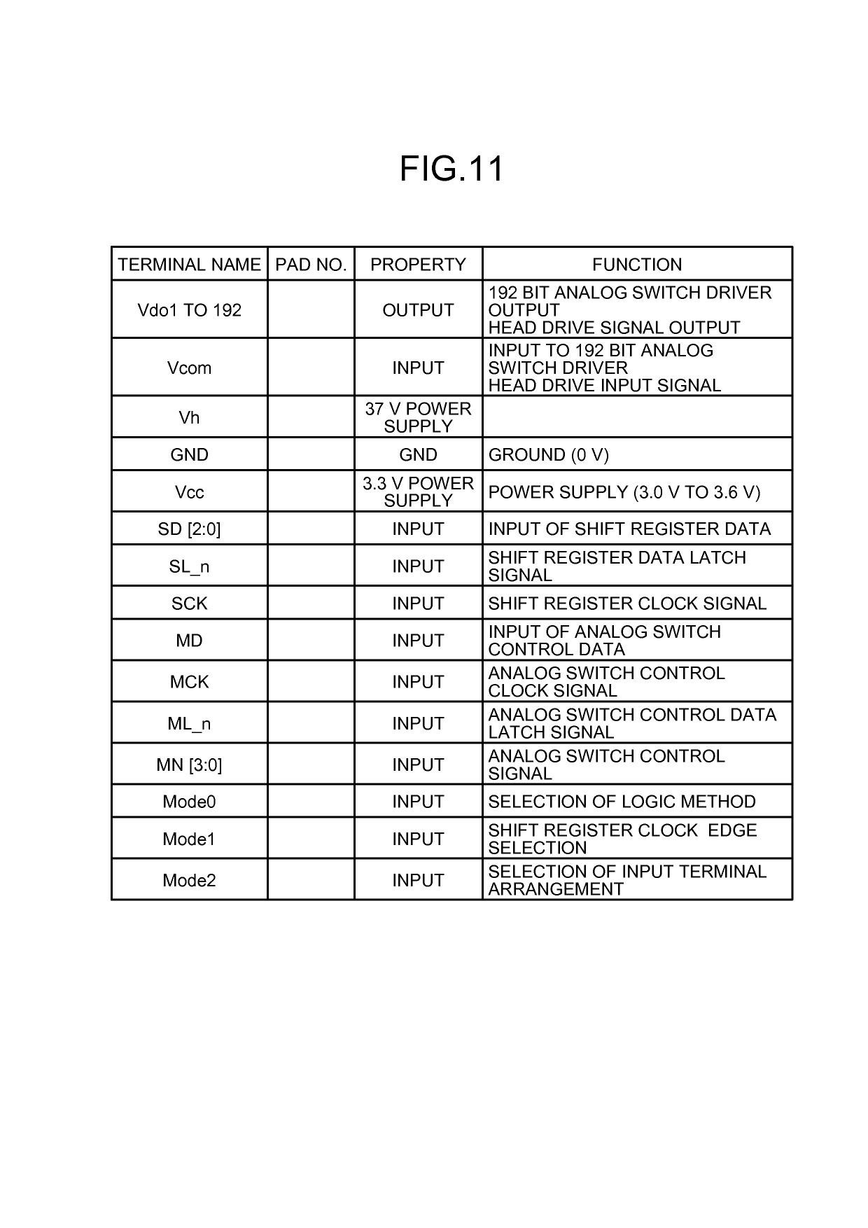

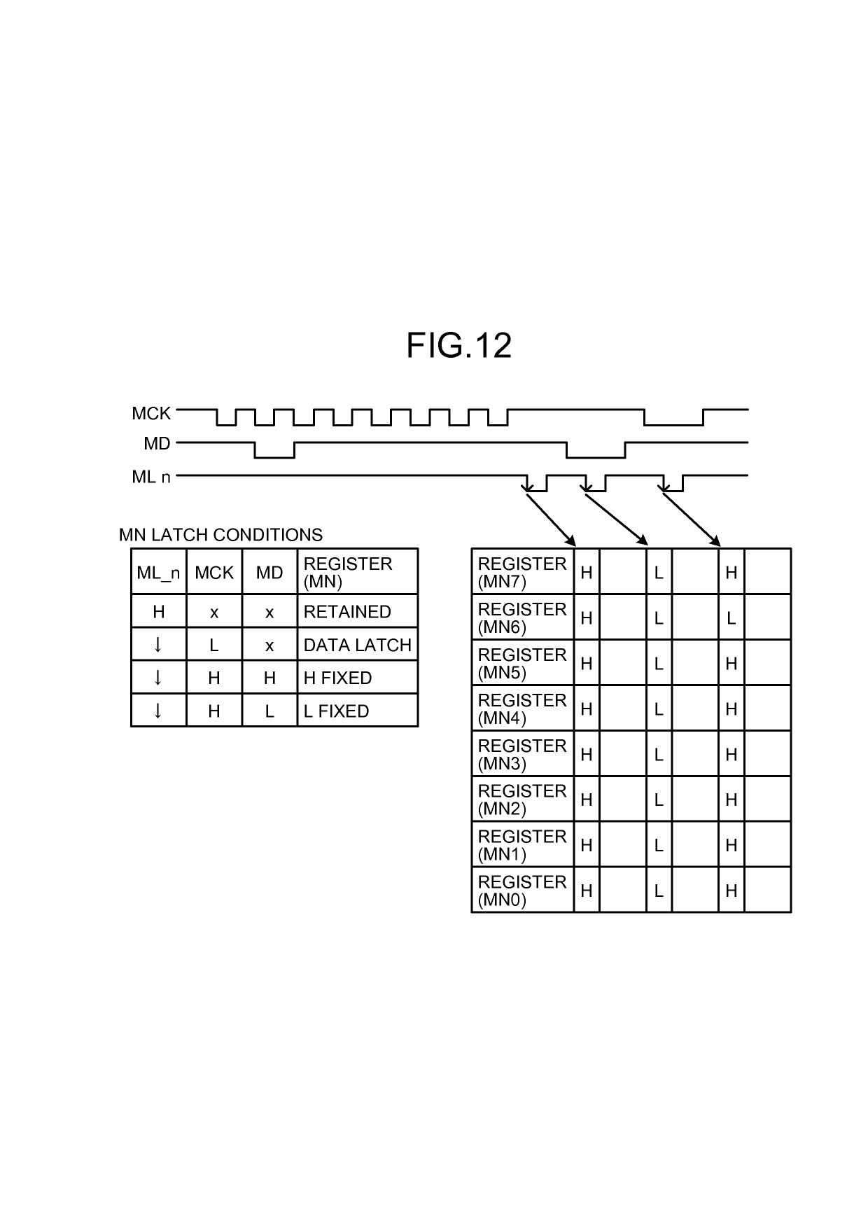

Next, a concrete example of a head drive module constituting the head driver 509 is described with reference to FIG. 10 to FIG. 12. FIG. 10 is an explanatory diagram illustrating a functional operation example of the head drive module. FIG. 11 is an explanatory diagram illustrating examples of signals input to the head drive module. FIG. 12 is an explanatory diagram illustrating examples of the droplet control data MD and the latch signal ML that are input to the head drive module, and the droplet control signal MN generated.

In the head drive module, liquid droplets with different sizes can be ejected selecting a plurality of drive pulses constituting the common drive waveform Vcom. FIG. 10 illustrates Examples of various kinds of input data and signals to the head drive module, and the shift of the output state.

Regarding the droplet control data (analog switch control data) MD, as illustrated in FIG. 12, the droplet control data MD is sent in serial transmission to the shift register 713 at timing with the shift clock signals MCK to be latched in the latch circuit 714 by the latch signals ML (represented as ML n in FIG. 12). The droplet control data MD is in accordance with a size of droplets to be ejected.

With the droplet control data MD latched in the latch circuit 714, eight kinds of droplet control signals MN0 to MN7 can be obtained in the example. That is, it is possible to eject droplets with eight different sizes at most (on the assumption that the common drive waveform Vcom is originally generated so as to allow selection of eight different sizes).

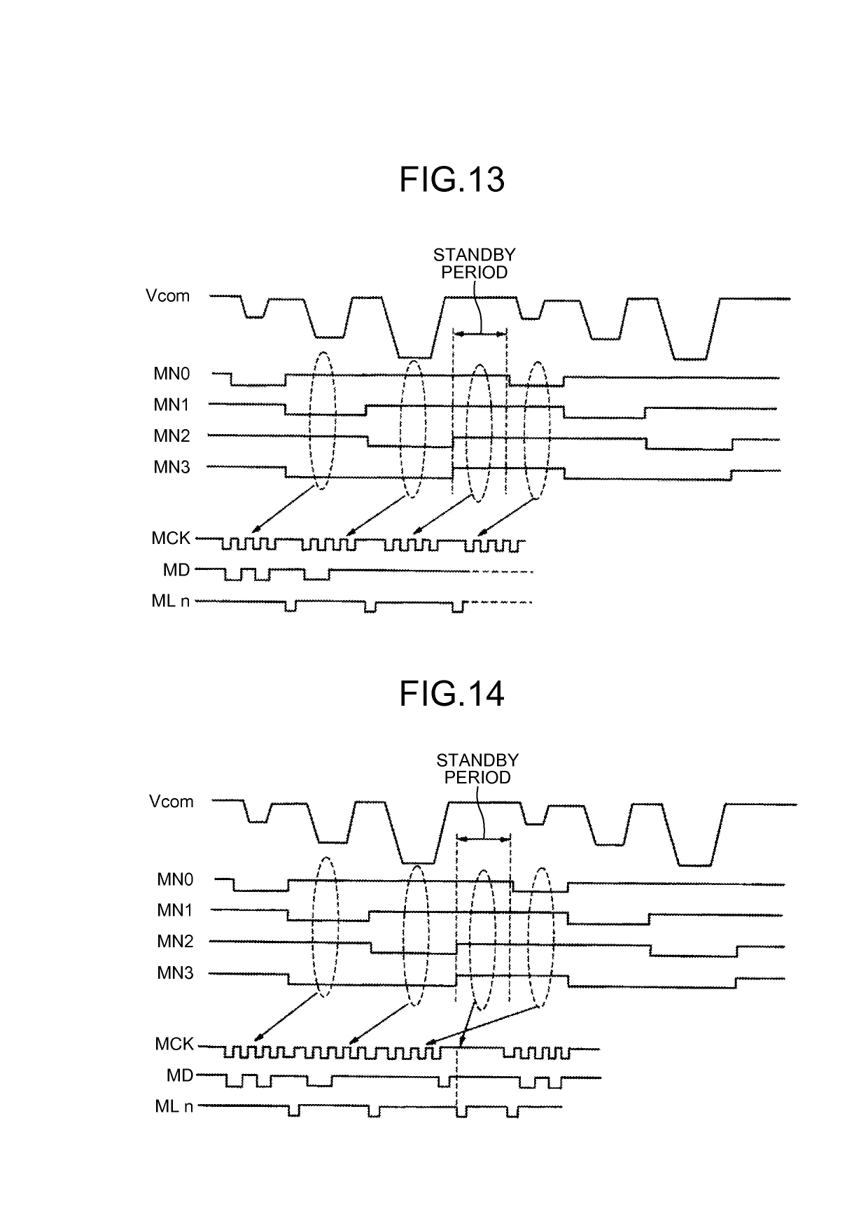

Next, the transmission format of the droplet control data from the data transmitting unit 702 to the head driver 509 is described with reference to FIG. 13 and FIG. 14. FIG. 13 is an explanatory diagram illustrating an example of parallel transmission, and FIG. 14 is an explanatory diagram illustrating an example of serial transmission.

First, in a parallel transmission technique, as illustrated in FIG. 13, all of the droplet control signals ML are shifted to “H” before the latch signals ML are changed after pixel data (image data) is transmitted. Note that the analog switch 717 is on when the droplet control signal ML is “H” here.

On the other hand, when the droplet control data is sent in serial transmission to form the droplet control signals, it is required to transmit droplet control data (mask data) only for changing all droplet control signals ML to “H” in order to perform the same operation as in parallel transmission.

However, when such data is transmitted, a drive waveform cannot be changed during the transmission. It makes time required for the transmission (1 μs, for example) useless in a drive cycle, and thus disabling the increase of a head drive frequency (increase of a print speed).

When the droplet control data MD is transmitted to turn on all of the analog switches 717 in an interval between drive waveforms (ejection standby period), it is required to transmit also initial droplet control data MD for a drive waveform of the subsequent drive cycle during the standby period.

However, considering the adjustment of reading time in the encoder (for detecting a carriage position) defining the retention time and the drive cycle of the shift clock, it is generally difficult to complete the transmission of the droplet control data MD to turn on all of the analog switches 717 and the transmission of the initial droplet control data MD for a drive waveform of the subsequent drive cycle, within the standby period. This aspect also disables high-speed drive (high frequency drive).

Then, a head drive module requires a mechanism in which, when both of the droplet control data MD and the latch signals ML are changed to “L”, all of the droplet control signals MN are changed to “H” as a preset value for avoiding useless time without any data transmission required.

In the head drive module of the embodiment, the preset value of the droplet control signals MN in serial transmission can be “H” in all of them besides “L” in all of them. That is, as illustrated in FIG. 14, with “H” in clock MCK and “L” in droplet control data MD, all of the droplet control signals MN can be “L” in the fall of latch signals ML.

When no measure against self-discharge is taken, the head drive module can select the setting in which, with “H” in clock MCK and “H” in droplet control data MD, all of the droplet control signals MN are to “H” in the fall of latch signals ML.

Here, the head drive module of the embodiment can be used for both cases of parallel transmission and serial transmission, and the structure thereof will be described.

With respect to an image forming apparatus, the performance of a driver IC (head driver) itself is needed to be improved more for performing high-speed printing, and the downsizing of the apparatus are demanded. These mainly depend on the difference of performance of driver ICs.

Here, necessary functions of a head drive module are different depending on models to which the module is provided. If driver ICs are developed for each of such models, the development costs can be raised. Thus, it is desirable to develop a driver IC that can be commonly used in various models.

As a technique for increasing speed in an image forming apparatus, the number of nozzles per one head can be increased. However, in order to drive a head with many nozzles, data transmission speed needs to be higher. Moreover, in order to improve image quality, it is necessary to increase the number of sizes of droplets to be ejected by making the image data multiplied. Consequently, it tends to increase a data amount necessary to be transmitted to the head. That is, a data transmission speed to a driver IC is increased, the data processing capacity of the driver IC is increased, and thereby, resulting in a higher processing speed of the apparatus as a result.

In general, a transmission speed is obviously higher in parallel transmission in which a plurality of bits are transmitted in parallel than in serial transmission in which bits are transmitted sequentially as long as the transmission performance of each data link is the same. However, it is difficult to provide long wires for parallel transmission because the wires for a plurality of bits are provided in parallel that can cause a problem among the wires, for example. Moreover, the parallel transmission has a disadvantage of vulnerability to influence of noise.

Specifically, when liquid droplets with various sizes are dotted distinctively with accompanying increased data length, the number of kinds of droplet control signals is increased in the structure for extracting necessary drive pulses from the common drive waveform by mask signals such as droplet control signals as described above. This requires many signal lines for all droplet control signals in parallel transmission, which causes the tendency of a larger head.

Parallel transmission requires simple and easy-to-arrange hardware for the image forming apparatus body; in other words, only a latch circuit for copying data is needed. Contrary, serial transmission requires a certain level of performance as a specification of the circuit in the body because the operation for converting serial transmission to parallel transmission is necessary, while the increase of the number of signal lines is suppressed, so that the performance of the apparatus is improved advantageously, which is essential for higher performance.

Then, when a single driver IC can be applied to both configurations of parallel transmission and serial transmission, a transmission format can be selected by signal control in the driver IC, even if the required specification is different depending on the models. Therefore, the versatility of the driver IC is improved, and thus the costs for new development can be reduced.

In addition, when a dual edge technique (double clock rate) is adopted in serial transmission, the double amount of processing can be performed as compared with in a single edge technique (non-double clock rate), which prevents grow in size of the apparatus even if the number of signal lines is decreased.

Thus, in the head drive module of the embodiment, the dual edge technique is adopted in the serial transmission technique, so that the specifications of the apparatus are improved including the downsizing of the apparatus.

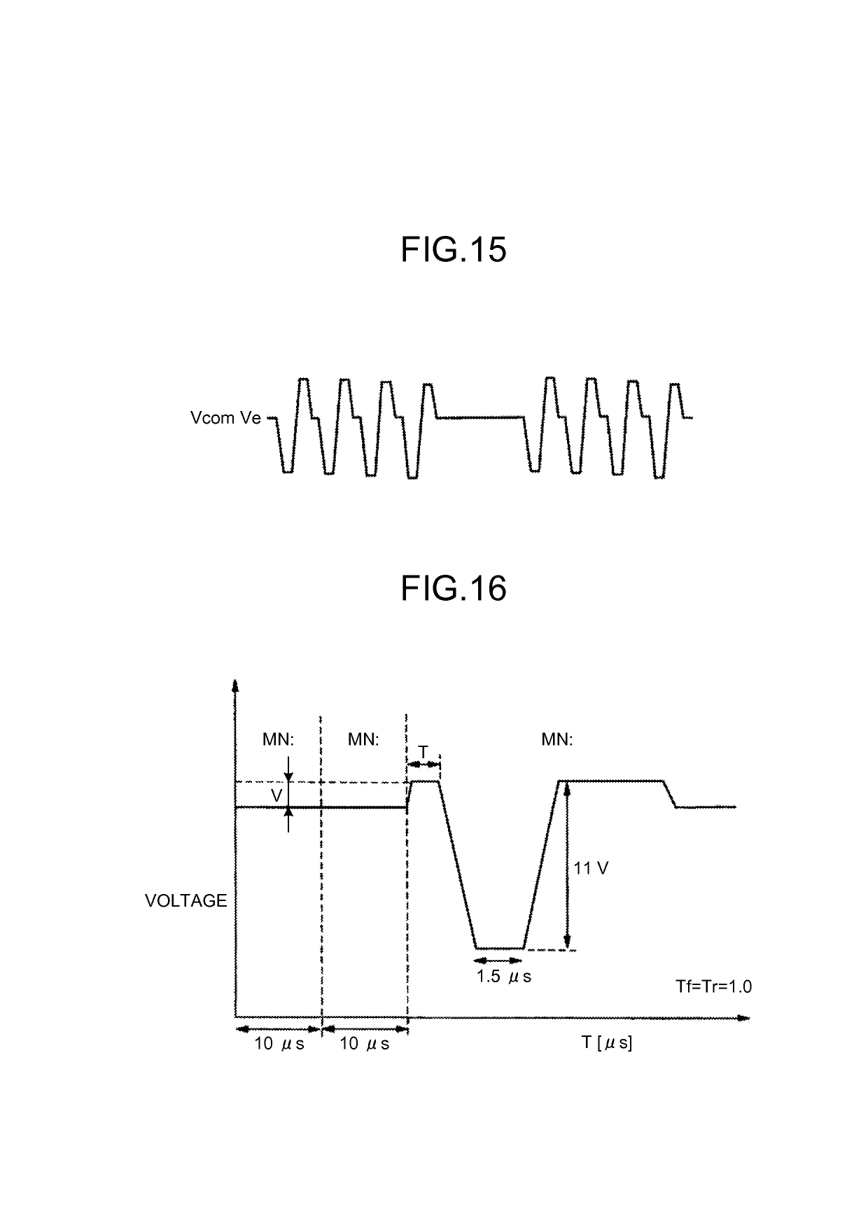

Next, with reference to FIG. 15, explanation is made on potential applied on the piezoelectric elements when all of the analog switches are turned on during an ejection waiting period between a drive waveform of one drive cycle and a drive waveform of the subsequent drive cycle.

As described above, the common drive waveform Vcom is a drive waveform having the reference potential Ve. Thus, the reference potential Ve that is the intermediate potential is applied on the piezoelectric member 112 (piezoelectric element PZT) when all of the analog switches 717 are turned on during an ejection waiting period between a drive waveform of one drive cycle and a drive waveform of the subsequent drive cycle.

In the embodiment, the reference potential Ve is set to be 20 V approximately.

Subsequently, the control for turning on all of the analog switches is described with reference to FIG. 16 to FIG. 18.

When voltage of the piezoelectric elements PZT is decreased due to self-charge, improper droplets are ejected (abnormal ejection) due to charge of the piezoelectric elements PZT to the intermediate potential in the subsequent drive waveform as described above, or abnormal ejection of droplets with a disordered speed is occurred due to vibration of meniscuses, etc.

Thus, in the embodiment, the detection control unit 703 monitors the intermediate potential between drive waveforms, and the data transmitting unit 702 shifts the states of the above-mentioned droplet control data MD, the clock signals MCK, and the latch signals ML when the voltage is decreased lower than a given threshold, so that all of the analog switches 717 are turned on. This prevents abnormal ejection caused by sudden charge of the piezoelectric element PZT in a subsequent drive waveform for compensating the decrease of voltage, and ejection abnormality due to the turbulence meniscuses.

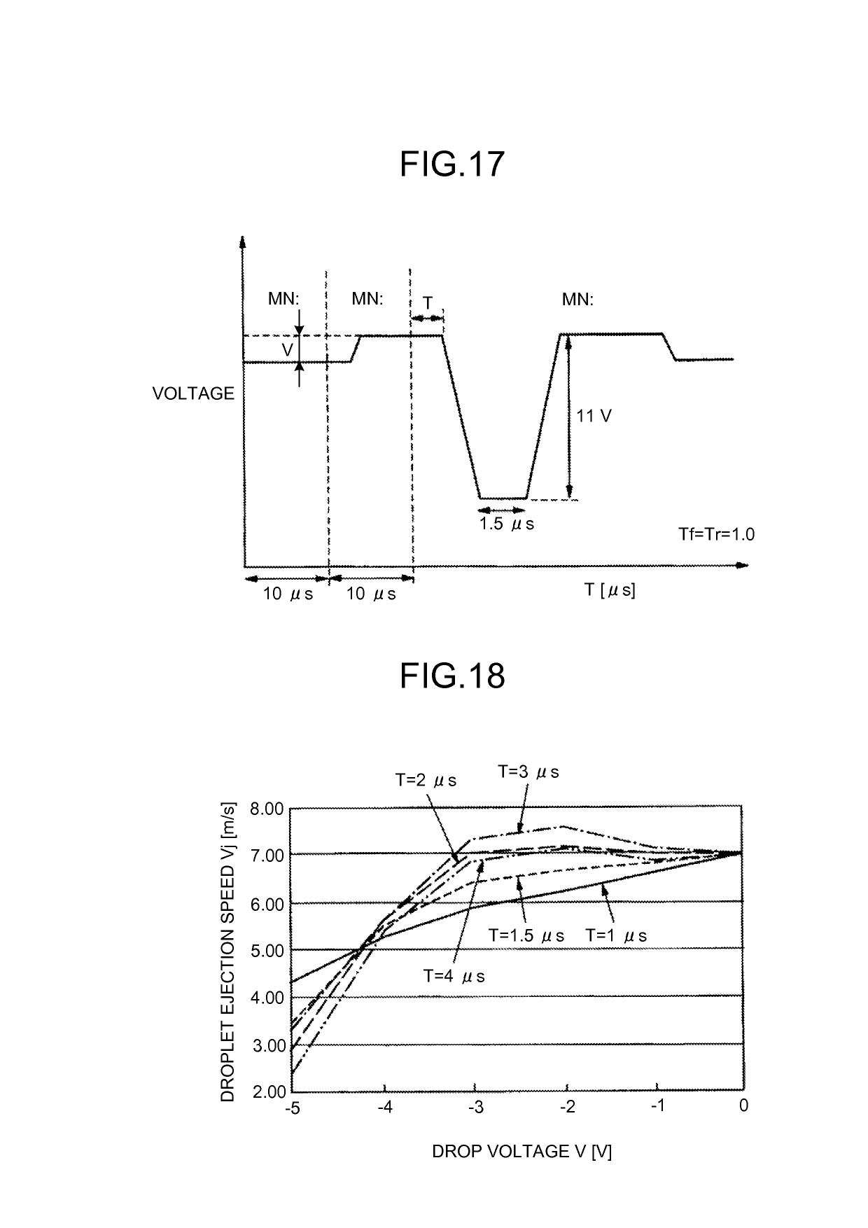

This aspect is described concretely. First, in relation to the influence of self-discharge of the piezoelectric element PZT on a droplet ejection speed, a droplet ejection speed is measured while changing the drop voltage V and the retention time T of the common drive waveform Vcom as illustrated in FIG. 16. FIG. 17 illustrates the change of voltage applied on the piezoelectric element PZT.

The change of a droplet ejection speed Vj here is illustrated in FIG. 18. According to the result in FIG. 18, in the cases of waveforms with shorter retention time T of 1 μs and 1.5 μs, the ejection speeds Vj are decreased as the drop voltages V are greater. On the other hand, in the cases of waveforms with retention time T of 2 μs or longer, the phenomenon is observed in which the ejection speeds Vj are increased at certain voltages. This is considered to be because the longer retention time T causes synchronization with a resonance period, and thus increasing an ejection speed Vj.

Here, assumed that a target droplet ejection speed Vj is set to be 7 m/s, and the tolerance thereof is 6%, the droplet ejection speed fluctuation range ΔVj is 0.42 m/s. The drop voltage V corresponding to this is 1 V in the example of FIG. 18.

When the retention time T is longer, a value of ΔVj can be within 0.42 m/s even if the drop voltage V exceeds 1 V. However, when the retention time T is longer, a length of the waveform is longer as a result, which disables a higher speed of drive cycles.

Thus, in the embodiment, when the detection control unit 703 detects that the intermediate potential of the common drive waveform Vcom is decreased lower than a threshold (=1 V), the data transmitting unit 701 shifts the states of the droplet control data MD, the clock signals MCK, and the latch signals ML, so that all of the analog switches 717 are turned on, that is, so that the droplet control signals MN become “L”.

This prevents ejection abnormality and abnormal ejection due to self-discharge.

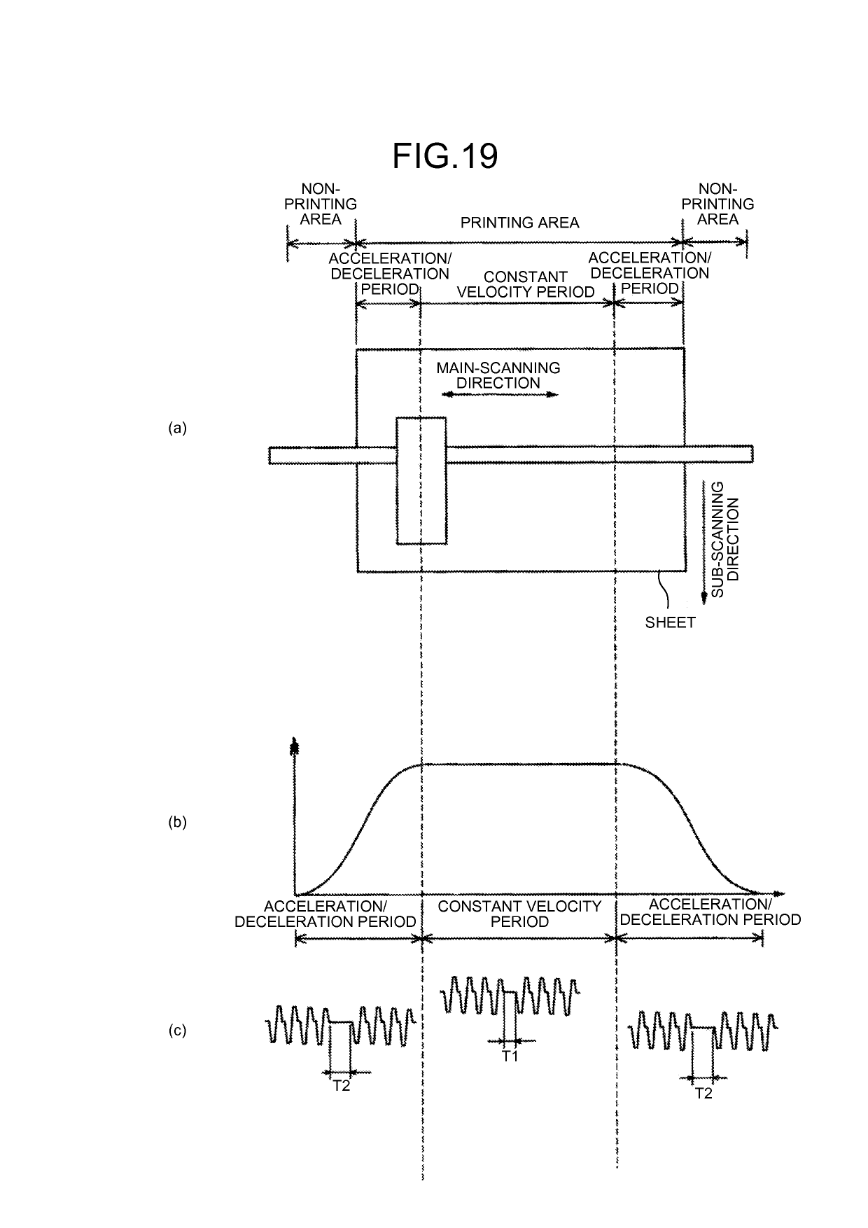

Next, the relation between a movement range and a movement speed of the carriage and a waiting period is described with reference to FIG. 19. FIG. 19 is an explanatory diagram illustrating the relation.

The movement range of the carriage 4 is divided to a non-printing area in which no image is formed, a printing area in which an image is formed, and another non-printing area in which no image is formed, as illustrated in FIG. 19(a).

The carriage speed in drive control of the carriage 4 is divided to an acceleration/deceleration period, a constant velocity period, and another acceleration/deceleration period, as illustrated in FIG. 19(b).

Here, in order to reduce the size of the apparatus, it is necessary to form an image even in the acceleration/deceleration periods of the carriage speed.

In the acceleration/deceleration periods of the carriage speed, the movement amount of the carriage per unit time is reduced as compared with in the constant velocity period. Thus, with respect to the waiting period of the drive waveform in each drive cycle, a waiting period T2 in the acceleration/deceleration periods is longer than a waiting period T1 in the constant velocity period, as illustrated in FIG. 19(c). Consequently, the decrease of voltage of the piezoelectric element due to self-charge becomes greater in the acceleration/deceleration periods.

Then, all of the analog switches are turned on during the waiting period of the drive waveform between drive cycles as described above, and thus it is possible to prevent a case in which liquid droplets are ejected improperly with decrease of voltage due to self-discharge so that image quality is deteriorated.

In the embodiment, a piezoelectric element is used as a pressure generating unit. However, it is also possible to use another pressure generating unit involving phenomena of self-discharge that operates in accordance with the change of potential, such as an electrostatic actuator that generates displacement by causing a potential difference between flexible electrodes facing each other, for example.

In the present application, the material of the “sheet” is not limited to paper, and includes an overhead projector (OHP) sheet, cloth, glass, a substrate, etc. on which ink droplets or other liquid can be attached. That is, the “sheet” includes a recorded medium, a recording medium, a recording sheet, a printing sheet, etc. It is assumed that the terms “image formation”, “recording”, “typing”, “imaging”, and “printing” are synonymous.

The “image forming apparatus” means an apparatus that performs image formation while ejecting liquid to a medium of paper, thread, fibers, fabric, leather, metal, plastic, glass, wood, ceramic, etc. Moreover, the “image formation” means not only addition of an image having some meaning such as characters or diagrams to a medium, but also addition of an image having no meaning such as a pattern to a medium (simple putting of liquid droplets on a medium).

The term “ink” is not limited to what is referred to as ink unless it is particularly limited, and used as a collective term for all liquid allowing image formation, such as printing liquid, fixing process liquid and liquid. The “ink” includes a deoxyribonucleic acid (DNA) sample, a resist, a pattern material, and resin, for example.

The “image” is not limited to planar one, and includes an image put on what is formed sterically, and an image formed by three-dimensional shaping of a solid itself.

The image forming apparatus includes a serial type image forming apparatus and a line type image forming apparatus, unless it is particularly limited.

The present invention can suppress, with a simple structure, the deterioration of image quality due to self-discharge of a pressure generating unit.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image forming apparatus, comprising:
a print head that includes
a plurality of nozzles ejecting liquid droplets, and
a plurality of pressure generating units generating pressure for ejecting liquid droplets from the nozzles;
a drive waveform generating unit that generates and outputs a drive waveform given to the pressure generating units of the print head in each drive cycle;
a head drive unit that includes
a switch unit connected to each of the pressure generating units, to which switch unit the drive waveform is input, and
a selection unit controlling the switch unit to be turned on and off in accordance with image data;
a monitoring unit that monitors intermediate potential of the drive waveform; and
a unit that outputs a signal for turning on all of the switch units to the selection unit, if the monitoring unit detects that voltage is decreased to lower than a predetermined threshold in an interval between the drive waveform of one drive cycle and the drive waveform of a subsequent drive cycle.

2. The image forming apparatus according to claim 1, wherein
the drive waveform includes a plurality of drive pulses for ejecting liquid droplets from the print head,
the selection unit includes
a unit to which droplet control data for selecting one or more drive pulses among the drive pulses of the drive waveform is input in serial transmission, and
a unit that latches the droplet control data input in the serial transmission with a latch signal, and
the selection unit turns on, when states of the droplet control data and the latch signal have been shifted to given states, all of the switch units while the image data is not input.

3. The image forming apparatus according to claim 1, further comprising
a carriage with the print head mounted thereon, the carriage being moved for scan in a main-scanning direction, wherein
liquid droplets are ejected from the print head in a constant velocity period and in an
acceleration/deceleration period of a moving speed of the carriage so as to form an image.

4. The image forming apparatus according to claim 1, wherein
intermediate potential of the drive waveform is applied on the pressure generating units when all of the switch units have been turned on.

5. The image forming apparatus according to claim 1, wherein
timing at which the switch units are turned on is changed in accordance with capacitance of the pressure generating units.

6. The image forming apparatus according to claim 5, wherein the timing at which the switch units are turned on is advanced as capacitance of the pressure generating units is smaller.
